(19) United States
(12) Patent Application Publication
(10) Pub. No.: US 2020/0402321 A1
(43) Pub. Date: Dec. 24, 2020

(54) METHOD, ELECTRONIC DEVICE AND STORAGE MEDIUM FOR IMAGE GENERATION

(71) Applicant: Beijing Dajia Internet Information Technology Co., Ltd., Beijing (CN)

(72) Inventors: Shanshan Wu, Beijing (CN); Paliwan Pahaerding, Beijing (CN); Bo Wang, Beijing (CN)

(21) Appl. No.: 17/014,755

(22) Filed: Sep. 8, 2020

(30) Foreign Application Priority Data
Oct. 23, 2019 (CN) 201911013672.5

(51) Int. Cl. G06T 19/00; G06F 3/01; G06T 7/536; G06T 7/70; G06F 3/042

(52) U.S. Cl. CPC G06T 19/006; G06F 3/011; G06T 2207/30196; G06T 7/70; G06F 3/0425; G06T 7/536

(57) ABSTRACT

Disclosed are a method, an electronic device and a storage medium for image generation. The method includes: determining plane coordinates of a drawing point in a first preset space based on a current operating position of a user; determining a depth coordinate of the drawing point in the first preset space based on a distance between the user's first preset part and the screen as well as a projection size of the user's first preset part on the screen at this distance; determining spatial position coordinates of the drawing point in the second preset space based on the plane coordinates and the depth coordinate; generating a spatial AR image based on the spatial position coordinates of the second preset space.

### CROSS REFERENCE TO RELATED APPLICATION

This application is based on and claims priority under 35 U.S.C. 119 to Chinese Patent Application No. 201911013672.5, filed on Oct. 23, 2019, in the China National Intellectual Property Administration. The entire disclosure of the above application is incorporated herein by reference.

### FIELD

The disclosure relates to the field of computer vision technology, and in particular to a method, an apparatus, an electronic device and a storage medium for image generation.

### BACKGROUND

As the application range of smart mobile devices becomes wider and wider, the shooting functions of smart mobile devices also become more and more powerful. The AR (Augmented Reality) is a technology that calculates the positions and angles of images taken by a camera in real time and adds the corresponding images, videos and animation models. The AR technology can blend the virtual world with the real world on the screen, for example, superimpose a virtual object model on the current video content scene to bring the more interesting and immersive experience to users.

In the related technologies, the process of drawing on the screen of an electronic device based on the AR technology is: acquiring the touch information when a user's finger touches the screen, determining the x-axis and y-axis coordinates of the touch point in the camera space, and then selecting a value within a predetermined range for the z-axis coordinate of the touch point, to obtain the coordinates of the touch point in the camera space, and then determining the coordinates of the touch point in the AR space through the spatial conversion. As the user's finger slides on the screen, the electronic device continuously receives the touch information generated during the finger sliding process and determines a series of points in the AR space, and can obtain the brush picture by rendering these points.

However, in the related technologies, since the coordinate value is a value set within a predetermined range and is independent of the user's own operation, it is easy to cause the poor sense of space of the spatial AR picture created by the user.

### SUMMARY

The disclosure provides a method, an apparatus, an electronic device and a storage medium for image generation.

According to a first aspect of an embodiment of the disclosure, a method for image generation is provided. The method includes: determining plane coordinates of a drawing point in a first preset space based on a current operating position of a user; determining a depth coordinate of the drawing point in the first preset space based on a distance between the user's first preset part and the screen as well as a projection size of the user's first preset part on the screen at this distance; determining spatial position coordinates of the drawing point in the second preset space based on the plane coordinates and the depth coordinate; generating a spatial AR image based on the spatial position coordinates of the second preset space.

According to a second aspect of an embodiment of the disclosure, an electronic device for image generation is provided. The electronic device includes a processor and a memory for storing instructions that can be executed by the processor. The processor is configured to execute the instructions to implement: determining plane coordinates of a drawing point in a first preset space based on a current operating position of a user; determining a depth coordinate of the drawing point in the first preset space based on a distance between the user's first preset part and the screen as well as a projection size of the user's first preset part on the screen at this distance; determining spatial position coordinates of the drawing point in the second preset space based on the plane coordinates and the depth coordinate; generating a spatial AR image based on the spatial position coordinates of the second preset space.

According to a third aspect of an embodiment of the disclosure, a storage medium for image generation is provided. The storage medium includes instructions. The instructions, when executed by a processor of an electronic device, enable the electronic device to perform: determining plane coordinates of a drawing point in a first preset space based on a current operating position of a user; determining a depth coordinate of the drawing point in the first preset space based on a distance between the user's first preset part and the screen as well as a projection size of the users first preset part on the screen at this distance; determining spatial position coordinates of the drawing point in the second preset space based on the plane coordinates and the depth coordinate; generating a spatial AR image based on the spatial position coordinates of the second preset space.

It should be understood that the above general description and the following detailed description are only exemplary and illustrative, and cannot limit the disclosure.

### BRIEF DESCRIPTION OF THE DRAWINGS

The accompanying drawings here are incorporated into and constitute a part of the specification, illustrate the embodiments conforming to the disclosure, and together with the specification, serve to explain the principles of the disclosure, but not constitute an improper limitation on the disclosure.

FIG. 1 is a schematic flow chart of an image generation method according to some embodiments;

FIG. 2 is a schematic flow chart of calculating the plane coordinates of the drawing point according to some embodiments;

FIG. 3 is another schematic flow chart of calculating the plane coordinates of the drawing point according to some embodiments;

FIG. 4 is a schematic flow chart of calculating the depth coordinate of the drawing point according to some embodiments;

FIG. 5 is a schematic diagram of a calculation model according to some embodiments;

FIG. 6A is a schematic diagram of the distribution of original points in space according to some embodiments;

FIG. 6B is a schematic diagram of discrete sheet-shaped particles according to some embodiments;

FIG. 6C is a schematic diagram of a strip-shaped continuous spatial AR brush image according to some embodiments;

FIG. 6D is a schematic diagram of placing a particle emitter at each point according to some embodiments;

FIG. 6E is a schematic diagram of a spatial AR brush image according to some embodiments;

FIG. 7 is a block diagram of an apparatus for image generation according to some embodiments;

FIG. 8 is a block diagram of an obtaining module according to some embodiments;

FIG. 9 is another block diagram of an obtaining module according to some embodiments;

FIG. 10 is a block diagram of a first calculation module according to some embodiments;

FIG. 11 is a block diagram of an apparatus according to some embodiments;

FIG. 12 is a block diagram of an apparatus according to some embodiments.

### DETAILED DESCRIPTION OF THE EMBODIMENTS

In order to enable those ordinary skilled in the art to better understand the technical solutions of the disclosure, the technical solutions in the embodiments of the disclosure will be described clearly and completely with reference to the accompanying drawings.

It should be noted that the terms such as “first”, “second” and the like in the specification and claims of the disclosure and the above drawings are used to distinguish the similar objects, but not necessarily to describe a particular order or sequence. It should be understood that the data used in this way is interchangeable under appropriate circumstances, so that the embodiments of the disclosure described herein can be implemented in an order other than those illustrated or described herein. The implementation modes described in the following exemplary embodiments do not represent all the implementation modes consistent with the disclosure. On the contrary, they are only the examples of the devices and methods which are detailed in the attached claims and consistent with some aspects of the disclosure.

FIG. 1 is a flow chart of a method for image generation according to some embodiments. As shown in FIG. 1, the method is used in a terminal, such as, a mobile phone, computer, digital broadcasting terminal, message transceiver, game console, tablet device, medical device, fitness device, and personal digital assistant. The method includes the following steps.

S101: acquiring a user's current operating position on a screen, and determining the plane coordinates of a drawing point in a first preset space according to the current operating position.

It can be understood that the corresponding operating information can be generated when the user operates to the screen, and thus the terminal can obtain the user's current operating position on the screen. For example, when the user makes a gesture above the screen, the camera can acquire information of the user's hand action to thereby obtain the user's current operating position on the screen; or when the user performs a sliding or clicking operation on the touch screen, the terminal can also obtain the user's current operating position on the screen according to the user's operation. Generally, the aforementioned operating position is represented by a pair of coordinates (respectively indicating the horizontal and vertical coordinates of the operating position). Therefore, after obtaining the current operating position, the terminal can conveniently map the coordinates corresponding to the current operating position into the first preset space, as the plane coordinates of the drawing point in the first preset space.

Here, the above first preset space may refer to the camera space. In the first preset space, the x axis, y axis, and z axis may respectively indicate six spatial directions of up and down, left and right, and front and back in the space. Therefore, the plane coordinates may refer to the x-axis and y-axis coordinates. The second preset space may refer to the space used to draw the spatial AR image therein. It can be understood that the second preset space also has a three-dimensional coordinate system, and the coordinates in the second preset the space can be mutually converted with the coordinates in the first preset space.

S102: calculating the depth coordinate of the drawing point in the first preset space based on the distance between the user's first preset part and the screen as well as the size of the projection of the user's first preset part on the screen at this distance.

When being used by the user, the terminal can detect the distance between the user's first preset part and the screen. For example, the distance between the user's hand and the screen can be detected through the distance sensor. When the user's first preset part is at the above distance, the terminal can further identify the projection size of the first preset part on the screen. For example, take an image containing the user's hand through a camera, and compare the size of the hand area in the image with the size of the terminal screen area, to thereby determine the proportion of the user's hand in the screen area and then determine a depth coordinate for representing the depth of the drawing point in the first preset space according to this proportion. It can be understood that, as the user's hand moves back and forth, the proportion will change and the depth coordinate will change accordingly. As can be seen, the depth coordinate in the embodiment of the disclosure establishes a connection with the user's first part, and is no longer a numerical value independent of the user, so that the user can adjust the depth of the image in space flexibly when creating the spatial AR image, making the image have the stronger sense of space and improving the usage experience of the user when creating the spatial AR image.

S103: calculating the spatial position coordinates of the drawing point in the second preset space based on the plane coordinates and the depth coordinate.

After the plane coordinates and depth coordinates of the drawing point are obtained, the coordinates of the drawing point in the first preset space are determined. Then the coordinate representation may be converted to the coordinate representation in the second preset space, to obtain the space position coordinates of the drawing point in the second preset space, that are expressed as (xₐᵣ, yₐᵣ, zₐᵣ).

S104: generating a spatial AR image based on the spatial position coordinates of the second preset space.

After the spatial position coordinates of the drawing point in the second preset space are determined, the spatial AR image (for example, a brush image) can be generated.

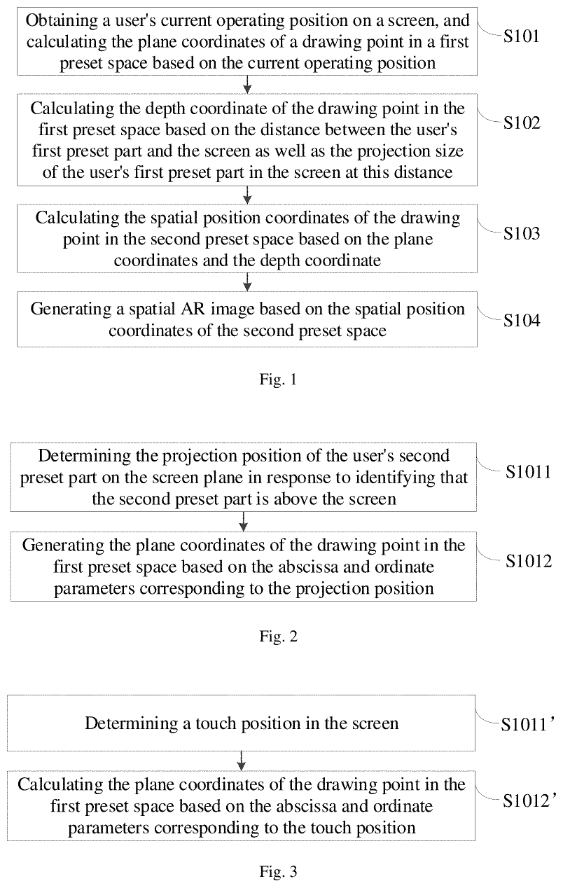

In some embodiments, as shown in FIG. 2, the above step S101 may include the following steps.

S1011: determining the projection position of the user's second preset part on the screen in response to identifying that the second preset part is above the screen.

In some embodiments, when the user's second part is above the screen, the terminal can take an image of the user's second part through the front camera, so as to determine the projection position of the second part on the screen plane. For example, when the second preset part is a finger, and after the camera takes an image of the finger, the position of the fingertip in the image can be determined. Then the projection position of the fingertip on the screen is obtained according to the parameters of the image (such as image resolution), the parameters of the screen (such as screen size, resolution, etc.) and other information, to determine the corresponding abscissa and ordinate coordinates of the fingertip on the screen.

S1012: generating the plane coordinates of the drawing point in the first preset space based on the abscissa and ordinate parameters corresponding to the projection position.

After obtaining the abscissa and ordinate parameters of the projection position, the terminal can calculate the plane coordinates of the drawing point in the camera space based on the above coordinate parameters.

For example, the obtained abscissa and ordinate parameters of the projection position are (x_{finger}, y_{finger}), and then above coordinate parameters can be converted, based on a preset conversion rule, into the plane coordinates in the first preset space, which are expressed as (2x_{finger}−1, 2y_{finger}−1). In some embodiments, the above preset conversion rule may be: the original coordinates are multiplied by 2 and then subtracted by 1 to obtain the new coordinates.

In some embodiments, as shown in FIG. 3, the above step S101 may include the following steps.

S1011′: determining a touch position in the screen in response to that the user touches the screen.

For the touch screen, the corresponding touch information is generated when the user touches the touch screen, and the terminal can easily determine the touch position based on the touch information, which can be expressed as (x_{touch}, y_{touch}).

S1012′: calculating the plane coordinates of the drawing point in the first preset space based on the abscissa and ordinate parameters corresponding to the touch position.

After the abscissa and ordinate parameters of the touch position are obtained, the above coordinate parameters can be converted into the plane coordinates in the first preset space based on a preset conversion rule. For example, the coordinates of the drawing point on a plane in the first preset space can be expressed as (2x_{touch}−1, 2y_{touch}−1). It can be understood that the depth information of the drawing point in the first preset space has not been determined at this time. In some embodiments, the above preset conversion rule may be: the original coordinates are multiplied by 2 and then subtracted by 1 to obtain the new coordinates.

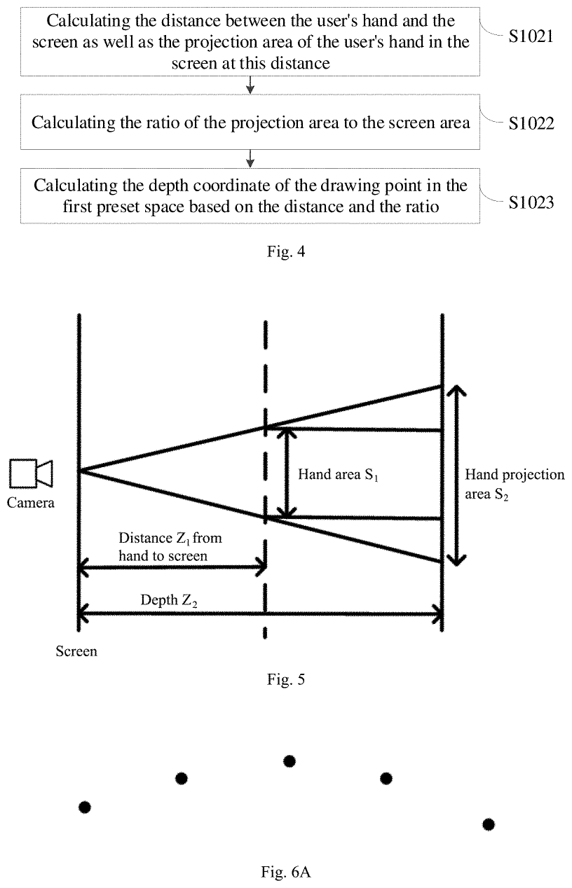

In some embodiments, the process of calculating the depth coordinate, as shown in FIG. 4, may include the following steps.

S1021: calculating the distance between the user's hand and the screen as well as the projection area of the user's hand in the screen at this distance.

S1022: calculating the ratio of the projection area to the screen area.

S1023: calculating the depth coordinate of the drawing point in the first preset space based on the distance and the ratio.

In some embodiments, the positional relationship of all parts in the calculation model is as shown in FIG. 5. Firstly, the distance Z₁ between the user's hand and the screen as well as the projection area S₂ of the user's hand in the screen at this distance are calculated, where the projection area may be the area of the hand in the image taken by the camera. In some embodiments, the projection area may be approximated as a circle in order to facilitate the calculation, and the area S₁ of the user's hand may also be approximated as a circle. The ratio may be calculated and expressed as s_{hand}. As shown in FIG. 5, there are two approximate triangles. It is easy to understand that the two approximate triangles correspond to two cones from a spatial perspective, and correspond to two circular bottom surfaces from a side view, which are represented by S₁ and S₂ respectively in FIG. 5. Then the following formula can be derived:

$${( \frac{{z}_{1}}{{z}_{2}} )}^{2} = \frac{{s}_{1}}{{s}_{2}} = {s}_{hand}$$

Thus, Z₂, i.e., the depth coordinate of the drawing point in the first preset space, is determined, and then the coordinates of the drawing point in the first preset space may be expressed as (2x_{finger}−1, 2 y_{finger}−1, z₂).

In some embodiments, the depth coordinate of the drawing point in the first preset space may be determined by using a preset expression, where the preset expression can be:

$${z}_{2} = \frac{{z}_{1}}{\sqrt{{s}_{hand}}}$$

where Z₂ represents the depth coordinate of the drawing point in the first preset space, Z₁ represents the distance between the user's hand and the screen, and s_{hand} represents the ratio of the projection area to the screen area. Then the coordinates of the drawing point in the first preset space may be expressed as

$$( 2 {x}_{finger} - 1 , 2 {y}_{finger} - 1 , \frac{{z}_{1}}{\sqrt{{s}_{hand}}} ) .$$

As such, in the present disclosure, the depth coordinate may be determined directly by calculating the ratio, thereby improving the calculation speed.

In some embodiments, a preset transformation matrix and the camera parameters may be used to convert the coordinates in the first preset space into the second preset space, to obtain the spatial position coordinates of the drawing point in the second preset space, which can be expressed as (xₐᵣ, yₐᵣ, zₐᵣ) The process can refer to the process of mutual conversion between the camera coordinate system and the world coordinate system in the related technology, which is not repeated here in the embodiment of the disclosure.

In some embodiments, the spatial AR images with different effects may be generated based on the spatial position coordinates of the second preset space in the preset rendering mode.

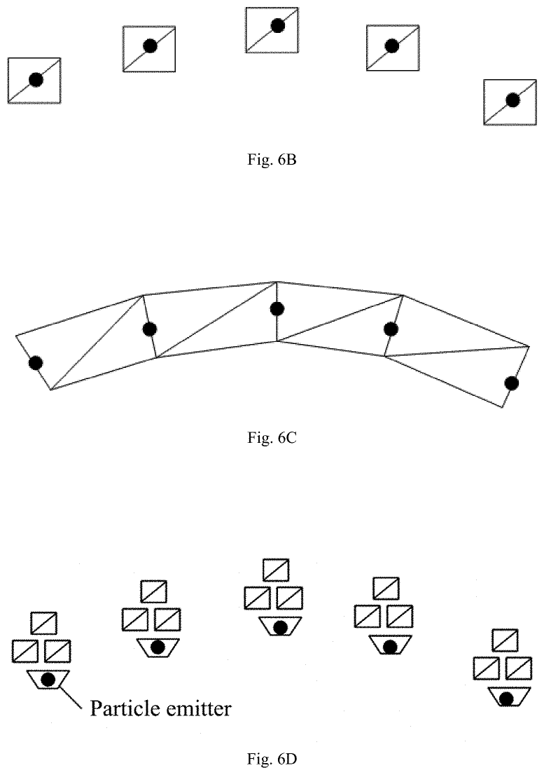

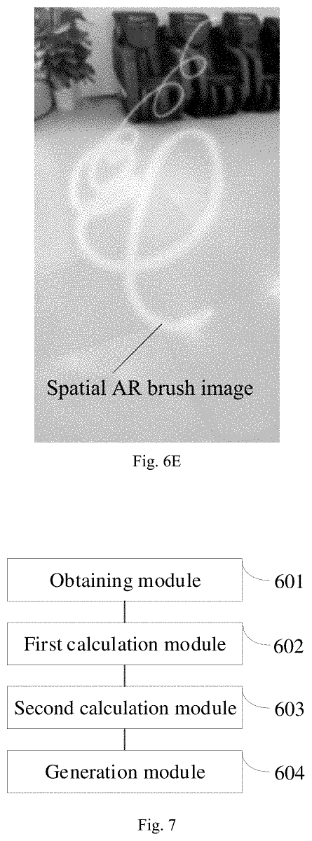

In some embodiments, a corresponding particle may be generated at point (xₐᵣ, yₐᵣ, zₐᵣ), and rendered into different brush effects according to different preset particle types. FIG. 6A is a schematic diagram of the distribution of original points in space. A discrete sheet-shaped particle, as shown in FIG. 6B, may be set at the position corresponding to each point to form a discrete sheet-shaped space of the AR brush image. In some embodiments, as shown in FIG. 6C, these discrete sheet-shaped particles are connected together to form a strip-shaped continuous spatial AR brush image. In some embodiments, as shown in FIG. 6D, a particle emitter is placed at the position corresponding to each point, the instructions are selected according to the user's brush effect to form the brush with different representations, and the presented continuous spatial AR brush image is as shown in FIG. 6E.

With the image generation method provided by the embodiments of the disclosure, the plane coordinates of the drawing point in the first preset space are calculated by obtaining the user's current operating position on the screen, then the depth coordinate of the drawing point in the first preset space is calculated based on the distance between the user's first preset part and the screen as well as the projection size of the user's first preset part in the screen at this distance, then the spatial position coordinates of the drawing point in the second preset space are calculated based on the plane coordinates and the depth coordinate, and the spatial AR image is generated based on the spatial position coordinates of the second preset space. Since the depth coordinate is determined according to the distance between the user's first preset part and the screen as well as the projection size of the user's first preset part in the screen at this distance, rather than a value independent of the user's operation, the user can adjust the depth of the spatial AR image in space by the distance between the first part and the screen, so that the user can create the spatial AR image with more spatial sense.

FIG. 7 is a block diagram of an apparatus for image generation according to some embodiments. Referring to FIG. 7, the apparatus includes:

an obtaining module 601 configured to obtain a user's current operating position on a screen, and calculate plane coordinates of a drawing point in a first preset space according to the current operating position, wherein the drawing point is a coordinate point to generate an AR image in a second preset space;

a first calculation module 602 configured to calculate a depth coordinate of the drawing point in the first preset space based on the distance between the user's first preset part and the screen as well as the projection size of the user's first preset part in the screen at this distance;

a second calculation module 603 configured to calculate spatial position coordinates of the drawing point in the second preset space based on the plane coordinates and the depth coordinate;

a generation module 604 configured to generate a spatial AR image based on the spatial position coordinates of the second preset space.

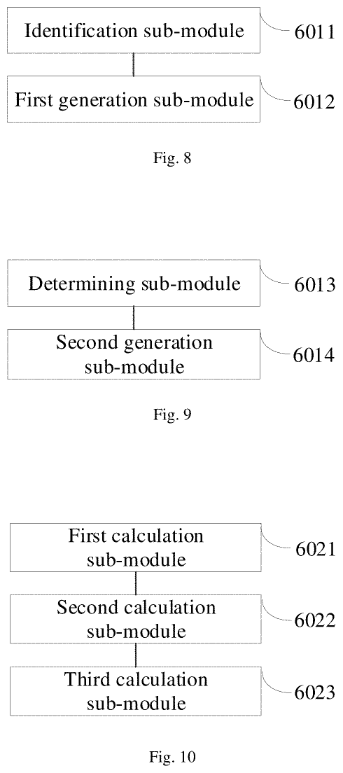

In some embodiments, as shown in FIG. 8, the above obtaining module includes:

an identification sub-module 6011 configured to determine the projection position of the user's second preset part on the screen plane in response to identifying that the second preset part is above the screen, where the second preset part includes: a finger or a fingertip;

a first generation sub-module 6012 configured to generate the plane coordinates of the drawing point in the first preset space according to abscissa and ordinate parameters corresponding to the projection position.

In some embodiments, as shown in FIG. 9, the above obtaining module includes:

a determining sub-module 6013 configured to determine a touch position in the screen when the user touches the screen;

a second generation sub-module 6014 configured to calculate the plane coordinates of the drawing point in the first preset space according to abscissa and ordinate parameters corresponding to the touch position.

In some embodiments, as shown in FIG. 10, the above first calculation module includes:

a first calculation sub-module 6021 configured to calculate the distance between the user's hand and the screen as well as the projection area of the user's hand in the screen at this distance;

a second calculation sub-module 6022 configured to calculate the ratio of the projection area to the screen area;

a third calculation sub-module 6023 configured to calculate the depth coordinate of the drawing point in the first preset space based on the distance and the ratio.

In some embodiments, the above third calculation sub-module is specifically configured to:

calculate the depth coordinate of the drawing point in the first preset space by using a preset expression, where the preset expression is:

$${z}_{2} = \frac{{z}_{1}}{\sqrt{{s}_{hand}}}$$

where Z₂ represents the depth coordinate of the drawing point in the first preset space, Z₁ represents the distance between the user's hand and the screen, and s_{hand} represents the ratio of the projection area to the screen area.

In some embodiments, the above second calculation module is configured to:

determine the spatial position coordinates of the drawing point in the second preset space by converting the plane coordinates and the depth coordinate to the coordinate system of the second preset space.

In some embodiments, the above generation module is configured to:

generate spatial AR images with different effects using the preset rendering mode, where the spatial AR images with different effects include: a discrete sheet-shaped spatial AR brush image, and a strip-shaped continuous space AR brush image.

With the apparatus provided by the embodiments of the disclosure, the plane coordinates of the drawing point in the first preset space are calculated by obtaining the user's current operating position on the screen, then the depth coordinate of the drawing point in the first preset space is calculated based on the distance between the user's first preset part and the screen as well as the projection size of the user's first preset part in the screen at this distance, then the spatial position coordinates of the drawing point in the second preset space are calculated based on the plane coordinates and the depth coordinate, and then the spatial AR image is generated at the spatial position coordinates of the second preset space. Since the depth coordinate is determined based on the distance between the user's first preset part and the screen as well as the projection size of the user's first preset part in the screen at this distance, rather than a value independent of the user's operation, the user can adjust the depth of the spatial AR image in space by the distance between the first part and the screen, so that the user can create the spatial AR image with more spatial sense.

Regarding the apparatus in the above embodiment, the specific manner in which each module performs the operations has been described in detail in the embodiment related to the method, and will not be illustrated in detail here.

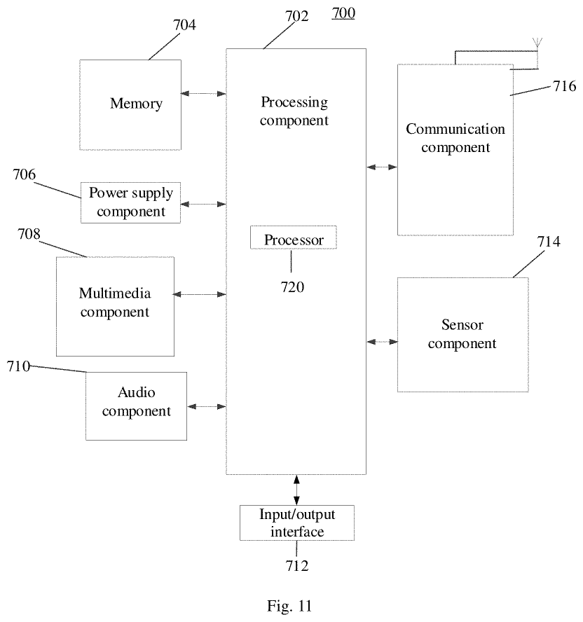

FIG. 11 is a block diagram of an electronic device 700 for image generation according to some embodiments. For example, the electronic device 700 may be a mobile phone, computer, digital broadcasting terminal, message transceiver, game console, tablet device, medical device, fitness device, personal digital assistant, or the like.

Referring to FIG. 11, the electronic device 700 may include one or more of a processing component 702, a memory 704, a power supply component 706, a multimedia component 708, an audio component 710, an input/output (I/O) interface 712, a sensor component 714, and a communication component 716.

The processing component 702 generally controls the overall operations of the electronic device 700, such as operations associated with display, phone call, data communication, camera operation, and recording operation. The processing component 702 may include one or more processors 720 to execute instructions to complete all or a part of the steps of the above method. In addition, the processing component 702 may include one or more modules to facilitate the interactions between the processing component 702 and other components. For example, the processing component 702 may include a multimedia module to facilitate the interactions between the multimedia component 708 and the processing component 702.

The memory 704 is configured to store various types of data to support the operations of the device 700. Examples of the data include instructions of any application program or method operated on the electronic device 700, contact person data, phone book data, messages, pictures, videos, and the like. The memory 704 may be implemented by any type of volatile or nonvolatile storage device or a combination thereof, such as Static Random Access Memory (SRAM), Electrically Erasable Programmable Read Only Memory (EEPROM), Erasable Programmable Read Only Memory (EPROM), Programmable Read Only Memory (PROM), Read Only Memory (ROM), magnetic memory, flash memory, magnetic disk or optical disk.

The power supply component 706 provides power for various components of the electronic device 700. The power supply component 706 may include a power management system, one or more power supplies, and other components associated with generating, managing and distributing the power for the electronic device 700.

The multimedia component 608 includes a screen of an output interface provided between the electronic device 700 and the user. In some embodiments, the screen may include a Liquid Crystal Display (LCD) and a Touch Panel (TP). If the screen includes a touch panel, the screen may be implemented as a touch screen to receive input signals from the user. The touch panel includes one or more touch sensors to sense the touching, the sliding, and the gestures on the touch panel. The touch sensor may not only sense the boundary of the touching or sliding operation, but also detect the duration and pressure related to the touching or sliding operation. In some embodiments, the multimedia component 708 includes a front camera and/or a rear camera. When the device 700 is in the operation mode such as shooting mode or video mode, the front camera and/or the rear camera may receive the external multimedia data. Each of the front camera and rear camera may be a fixed optical lens system or have the focal length and the optical zoom capability.

The audio component 710 is configured to output and/or input audio signals. For example, the audio component 710 includes a microphone (MIC). When the electronic device 700 is in the operation mode such as call mode, recording mode and voice recognition mode, the microphone is configured to receive the external audio signals. The received audio signals may be further stored in the memory 704 or transmitted via the communication component 716. In some embodiments, the audio component 710 further includes a speaker for outputting the audio signals.

The I/O interface 712 provides an interface between the processing component 702 and a peripheral interface module, where the above peripheral interface module may be a keyboard, a click wheel, buttons or the like. These buttons may include but not limited to: home button, volume button, start button, and lock button.

The sensor component 714 includes one or more sensors for providing the electronic device 700 with the state assessments in various aspects. For example, the sensor component 714 may detect the opening/closing state of the device 700, and the relative positioning of the components (for example, the display and keypad of the electronic device 700). The sensor component 714 may further detect the position change of the electronic device 700 or a component of the electronic device 700, the presence or absence of contact of the user with the electronic device 700, the orientation or acceleration/deceleration of the electronic device 700, and the temperature change of the electronic device 700. The sensor component 714 may include a proximity sensor configured to detect the presence of nearby objects with no physical contact. The sensor component 714 may further include a light sensor, such as CMOS or CCD image sensor, for use in the imaging applications. In some embodiments, the sensor component 714 may further include an acceleration sensor, a gyro sensor, a magnetic sensor, a pressure sensor, or a temperature sensor.

The communication component 716 is configured to facilitate the wired or wireless communications between the electronic device 700 and other devices. The electronic device 700 may access a wireless network based on a communication standard, such as WiFi, operator network (e.g., 2G, 3G, 4G or 5G), or a combination thereof. In an exemplary embodiment, the communication component 716 receives the broadcast signal or broadcast related information from an external broadcast management system via a broadcast channel. In an exemplary embodiment, the communication component 716 further includes a Near Field Communication (NFC) module to facilitate the short-range communications. For example, the NFC module may be implemented based on the Radio Frequency IDentification (RFID) technology, Infrared Data Association (IrDA) technology, Ultra-WideBand (UWB) technology, Bluetooth (BT) technology and other technologies.

In some embodiments, the electronic device 700 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors or other electronic elements to perform the above image generation method.

In some embodiments, a non-transitory computer readable storage medium including instructions, for example, the memory 704 including instructions, is further provided, where the above instructions can be executed by the processor 720 of the electronic device 700 to complete the above method. For example, the non-transitory computer readable storage medium may be ROM, Random Access Memory (RAM), CD-ROM, magnetic tape, floppy disk, optical data storage device, or the like.

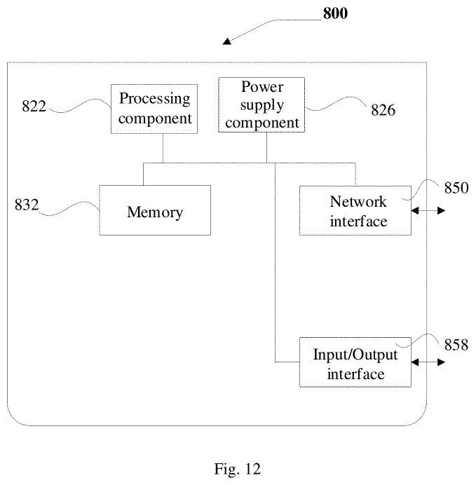

FIG. 12 is a block diagram of an apparatus 800 according to some embodiments. For example, the apparatus 800 may be provided as a server. Referring to FIG. 12, the apparatus 800 includes a processing component 822 which further includes one or more processors, and the memory resource represented by a memory 832 for storing the instructions (e.g., application program) that can be executed by the processing component 822. The application program stored in the memory 832 may include one or more modules, each of which corresponds to a set of instructions. In addition, the processing component 822 is configured to execute the instructions to perform the above image generation method.

The apparatus 800 may further include a power supply component 826 configured to perform the power management of the apparatus 800, a wired or wireless network interface 850 configured to connect the apparatus 800 to a network, and an Input/Output (I/O) interface 858. The apparatus 800 may operate based on an operating system stored in the memory 832, e.g., Windows, Server™, Mac OS X™, Unix™, Linux™, FreeBSD™ or the like.

After considering the specification and practicing the disclosure herein, those skilled in the art will readily come up with other embodiments. The disclosure is intended to encompass any variations, usages or applicability changes of the disclosure, and these variations, usages or applicability changes follow the general principle of the disclosure and include the common knowledge or customary technological means in the technical field which is not disclosed in the disclosure. The specification and embodiments are illustrative only, and the true scope and spirit of the disclosure is pointed out by the appended claims.

It should be understood that the disclosure is not limited to the precise structures which have been described above and shown in the figures, and can be modified and changed without departing from the scope of the disclosure. The scope of the disclosure is only limited by the attached claims.

What is claimed is:

1. A method for image generation, comprising:
determining plane coordinates of a drawing point in a first preset space based on a current operating position of a user;
determining a depth coordinate of the drawing point in the first preset space based on a distance between the user's first preset part and the screen as well as a projection size of the user's first preset part on the screen at this distance;
determining spatial position coordinates of the drawing point in the second preset space based on the plane coordinates and the depth coordinate;
generating a spatial AR image based on the spatial position coordinates of the second preset space.

2. The method according to claim 1, wherein said that determining plane coordinates of a drawing point in a first preset space comprises:
determining a projection position of the user's second preset part on a screen plane, in response to identifying that the second preset part is above the screen;
generating the plane coordinates according to abscissa and ordinate parameters corresponding to the projection position.

3. The method according to claim 1, wherein said that determining plane coordinates of a drawing point in a first preset space comprises:
determining a touch position on the screen;
calculating the plane coordinates according to abscissa and ordinate parameters of the touch position.

4. The method according to claim 1, wherein said that determining a depth coordinate of the drawing point in the first preset space comprises:
calculating a distance between the user's hand and the screen as well as a projection area of the user's hand on the screen at this distance;
calculating a ratio of the projection area to a screen area;
determining the depth coordinate based on the distance and the ratio.

5. The method according to claim 4, wherein said that determining the depth coordinate based on the distance and the ratio comprises:
calculating the depth coordinate by using a preset expression, wherein the preset expression is:
$${z}_{2} = \frac{{z}_{1}}{\sqrt{{s}_{hand}}}$$
wherein Z₂ represents the depth coordinate, Z₁ represents the distance, and s_{hand} represents the ratio.

6. The method according to claim 1, wherein said that determining spatial position coordinates of the drawing point in the second preset space comprises:
determining the spatial position coordinates of the drawing point in the second preset space by converting the plane coordinates and the depth coordinate to a coordinate system of the second preset space.

7. The method according to claim 1, wherein said that generating a spatial AR image comprises:
generating the spatial AR image using a preset rendering mode;
wherein the spatial AR image comprises: a discrete sheet-shaped spatial AR brush image, and a strip-shaped continuous space AR brush image.

8. An electronic device, comprising:
a processor;
a memory for storing instructions that can be executed by the processor;
wherein the processor is configured to execute the instructions to implement:
determining plane coordinates of a drawing point in a first preset space based on a current operating position of a user;
determining a depth coordinate of the drawing point in the first preset space based on a distance between the user's first preset part and the screen as well as a projection size of the user's first preset part on the screen at this distance;
determining spatial position coordinates of the drawing point in the second preset space based on the plane coordinates and the depth coordinate;
generating a spatial AR image based on the spatial position coordinates of the second preset space.

9. The electronic device according to claim 8, wherein said that determining plane coordinates of a drawing point in a first preset space comprises:
determining a projection position of the user's second preset part on a screen plane, in response to identifying that the second preset part is above the screen;
generating the plane coordinates according to abscissa and ordinate parameters corresponding to the projection position.

10. The electronic device according to claim 8, wherein said that determining plane coordinates of a drawing point in a first preset space comprises:
determining a touch position on the screen;
calculating the plane coordinates according to abscissa and ordinate parameters of the touch position.

11. The electronic device according to claim 8, wherein said that determining a depth coordinate of the drawing point in the first preset space comprises:
calculating a distance between the user's hand and the screen as well as a projection area of the user's hand on the screen at this distance;
calculating a ratio of the projection area to a screen area;
determining the depth coordinate based on the distance and the ratio.

12. The electronic device according to claim 11, wherein said that determining the depth coordinate based on the distance and the ratio comprises:
calculating the depth coordinate by using a preset expression, wherein the preset expression is:
$${z}_{2} = \frac{{z}_{1}}{\sqrt{{s}_{hand}}}$$
wherein Z₂ represents the depth coordinate, Z₁ represents the distance, and s_{hand} represents the ratio.

13. The electronic device according to claim 8, wherein said that determining spatial position coordinates of the drawing point in the second preset space comprises:
determining the spatial position coordinates of the drawing point in the second preset space by converting the plane coordinates and the depth coordinate to a coordinate system of the second preset space.

14. The electronic device according to claim 8, wherein said that generating a spatial AR image comprises:
generating the spatial AR image using a preset rendering mode;
wherein the spatial AR image comprises: a discrete sheet-shaped spatial AR brush image, and a strip-shaped continuous space AR brush image.

15. A storage medium, comprising instructions therein, wherein when executed by a processor of an electronic device, the instructions enable the electronic device to perform:
determining plane coordinates of a drawing point in a first preset space based on a current operating position of a user;
determining a depth coordinate of the drawing point in the first preset space based on a distance between the user's first preset part and the screen as well as a projection size of the user's first preset part on the screen at this distance;
determining spatial position coordinates of the drawing point in the second preset space based on the plane coordinates and the depth coordinate;
generating a spatial AR image based on the spatial position coordinates of the second preset space.

16. The storage medium according to claim 15, wherein said that determining plane coordinates of a drawing point in a first preset space comprises:
determining a projection position of the user's second preset part on a screen plane, in response to identifying that the second preset part is above the screen;
generating the plane coordinates according to abscissa and ordinate parameters corresponding to the projection position.

17. The storage medium according to claim 15, wherein said that determining plane coordinates of a drawing point in a first preset space comprises:
determining a touch position on the screen;
calculating the plane coordinates according to abscissa and ordinate parameters of the touch position.

18. The storage medium according to claim 15, wherein said that determining a depth coordinate of the drawing point in the first preset space comprises:
calculating a distance between the user's hand and the screen as well as a projection area of the user's hand on the screen at this distance;
calculating a ratio of the projection area to a screen area;
determining the depth coordinate based on the distance and the ratio.

19. The storage medium according to claim 18, wherein said that determining the depth coordinate based on the distance and the ratio comprises:
calculating the depth coordinate by using a preset expression, wherein the preset expression is:
$${z}_{2} = \frac{{z}_{1}}{\sqrt{{s}_{hand}}}$$
wherein Z₂ represents the depth coordinate, Z₁ represents the distance, and s_{hand} represents the ratio.

20. The storage medium according to claim 15, wherein said that determining spatial position coordinates of the drawing point in the second preset space comprises:
determining the spatial position coordinates of the drawing point in the second preset space by converting the plane coordinates and the depth coordinate to a coordinate system of the second preset space.
